(19) United States
(12) Patent Application Publication
(10) Pub. No.: US 2023/0371677 A1
(43) Pub. Date: Nov. 23, 2023

(54) INTELLIGENT COSMETIC MIRROR WITH DISPLAY FUNCTION

(71) Applicant: Shanghai Yanwei Technology Co., Ltd., Shanghai (CN)

(72) Inventor: Yuhai JIA, Shuangyashan (CN)

(21) Appl. No.: 17/945,319

(22) Filed: Sep. 15, 2022

(30) Foreign Application Priority Data
May 17, 2022 (CN) 2022211930466

(51) Int. Cl. A45D 44/00; G09G 5/10; H04N 5/232

(52) U.S. Cl. CPC A45D 44/005; G09G 5/10; H04N 5/23293; G09G 2360/145; G09G 2360/06

(57) ABSTRACT

An intelligent cosmetic mirror with a display function is provided and includes a mirror. A display screen is disposed on a mirror surface of the mirror. The mirror is provided with a circuit board inside. The circuit board is provided with a display circuit. The display circuit includes a power manager, a microcontroller unit based (MCU-based) main controller, a switch controller, a photosensitive circuit, and a brightness adjuster. The power manager is used to provide power to the MCU-based main controller. The MCU-based main controller is used to control the photosensitive circuit through the switch controller. The photosensitive circuit is used to control the display screen through the brightness adjuster. The cosmetic mirror has strong practicability and various functions, which can not only make up but also carry out teaching demonstrate and guidance at the same time of the making up, and is safe and reliable to use.

### TECHNICAL FIELD

The disclosure relates to the technical field of display, in particular to an intelligent cosmetic mirror with a display function.

### BACKGROUND

The existing cosmetic mirror usually includes mirror surface and frame, which has the basic mirror function. However, its function is too single when women use it to make up, which can't give them teaching demonstration and guidance. Therefore, the existing cosmetic mirror can't meet female consumers' needs and the requirements of social development.

Patent application number of China: 201120260581.4, the application date: Jul. 21, 2011, and the publication date: Apr. 4, 2012. The patent name: intelligent mirror touch display system. The patent discloses an intelligent mirror touch display system, which includes a displayer, unidirectional transparent coated glass, a controller storing current display information, a server preset with identification tag information, a communication module, an identification label, a detection antenna that is used to read and send people's recognition tag information and a touch layer. The coated glass is attached to the front end of the displayer, and the touch layer is attached to the front end of the coated glass; the output of the RFID antenna is connected to the input of the controller, the output of the touch layer is connected to the input of the controller, the output of the controller is connected to the input of the displayer, and the controller communicates with the server through the communication module. The patent integrates RFID, intelligent control and other technologies. It not only has the functions of a mirror and a displayer, but also can realize man-machine interaction. Furthermore, it can update the display information of the displayer according to actual needs, thus meeting the requirements of multi-function and diversification in some places.

The above-mentioned patent document disclose an intelligent mirror touch display system, but it is not very practical, without comprehensive functions, and it is inconvenient for women to make up, which cannot meet consumers' needs.

### SUMMARY

In view of this, a main purpose of the disclosure is to provide an intelligent cosmetic mirror with a display function, which is highly practical and has various functions, it can not only make up but also carry out teaching demonstration and guidance while making up, and it is safe and reliable to use.

In order to achieve the above purpose, the disclosure proposes the intelligent cosmetic mirror with the display function, including a mirror. A display screen is disposed on a mirror surface of the mirror. The mirror is provided with a circuit board inside, the circuit board is provided with a display circuit. The display circuit includes a power manager, a microcontroller unit based (MCU-based) main controller, a switch controller, a photosensitive circuit, and a brightness adjuster;

the power manager is configured to provide a power to the MCU-based main controller, the MCU-based main controller is configured to control the photosensitive circuit through the switch controller, and the photosensitive circuit is configured to control the display screen through the brightness adjuster.

In an embodiment, the MCU-based main controller includes a LT 3599 chip.

In an embodiment, the power manager includes a charging circuit, and the charging circuit is configured to charge the power manager.

In an embodiment, the MCU-based main controller includes a camera, the camera is configured to collect image information.

In an embodiment, the MCU-based main controller includes a detector, the detector is configured to detect information processed by the MCU-based main controller.

In an embodiment, the MCU-based main controller includes a memory, the memory is configured to store information processed by the MCU-based main controller.

In an embodiment, the display circuit includes an audio player and a speaker, the MCU-based main controller is configured to control the audio player through the switch controller, the audio player is configured to control the audio signal output through the speaker.

In an embodiment, the photosensitive circuit includes a sharpness controller and a bright color adjuster, the MCU-based main controller is configured to control the photosensitive circuit through the switch controller, and the photosensitive circuit is configured to control the bright color adjuster through the sharpness controller.

In an embodiment, the mirror surface is provided with a key switch.

In an embodiment, a bottom of the mirror surface is provided with a support frame.

The beneficial effects of the technical solutions provided by the disclosure are as follows: 1) the display screen is provided on the mirror surface, and the mirror is provided with the display circuit therein. The display circuit controls the display screen for video display through the MCU-based main controller. This not only can make up but also can teach and demonstrate guidance at the same time of making up, which enhances the function of the cosmetic mirror and further enhances the utility of the cosmetic mirror; 2) the cosmetic mirror provided by the disclosure is strong, functional and more convenient to use, which is loved by female consumers; 3) the cosmetic mirror provided by the disclosure is low cost, safe, reliable and suitable for universal promotion.

### BRIEF DESCRIPTION OF DRAWINGS

In order to illustrate more clearly embodiments of the disclosure or the technical solutions in the prior art, the following will briefly introduce the attached drawings that need to be used in the description of the embodiments or the prior art. It is obvious that the attached drawings in the following description are only some embodiments of the disclosure. For those skilled in the art, without paying creative labor, other drawings can also be obtained from the structure shown in these drawings.

FIG. 1 is a schematic structural diagram of an intelligent cosmetic mirror with a display function according to an embodiment of the disclosure.

FIG. 2 is a schematic structural diagram of the intelligent cosmetic mirror with the display function according to the embodiment of the disclosure.

FIG. 3 is a schematic block diagram of a display circuit of an intelligent cosmetic mirror with a display function according to an embodiment of the disclosure.

### DESCRIPTION OF REFERENCE NUMERALS

| Reference | |
|---|---|
| numeral | Description |
| 10 | Mirror |
| 20 | Mirror surface |
| 30 | Display screen |
| 40 | Support frame |
| 50 | Key switch |
| 60 | Circuit board |
| 70 | Speaker |
| 100 | Power manager |
| 110 | Charging circuit |
| 200 | MCU-based main |
| | controller |
| 210 | Detector |
| 220 | Memory |
| 230 | Camera |
| 300 | Switch controller |
| 400 | Photosensitive circuit |
| 410 | Sharpness controller |
| 420 | Bright color adjuster |
| 500 | Brightness adjuster |
| 600 | Audio player |

The realization of the purpose, functional features and advantages of the disclosure will be further described with reference to the attached drawings in combination with the embodiments.

### DETAILED DESCRIPTION OF EMBODIMENTS

The technical solutions in the embodiments of the disclosure will be clearly and completely described below in combination with the drawings in the embodiments of the disclosure. Obviously, the described embodiments are only part of the embodiments of the disclosure, not all of them. Based on the embodiments in the disclosure, all other embodiments obtained by those skilled in the art without creative work should be within the scope of the disclosure.

It should be noted that all directional indications (such as up, down, left, right, front, rear . . . ) in the embodiment of the disclosure are only used to explain the relative position relationship and motion among components in a specific position (as shown in the attached drawings). If the specific position changes, the directional indications will also change accordingly.

In the disclosure, unless specific provisions and limitations, the terms “connect”, “fix” and etc., should be understood in a broad sense. For example, “fix” can be a fixed connection, a detachable connection, or integrated into one; it can be a mechanical connection or an electrical connection; it can be directly connected or indirectly connected through an intermediate medium. It can be the connection within two elements or the interactive relationship between two elements, unless the specific provisions and limitations, for those skilled in the art, the specific meaning of the above terms in the disclosure can be understood according to the specific situation.

In addition, the description of “first”, “second” and etc., in the disclosure is only for descriptive purposes, and cannot be understood as indicating or implying its relative importance or implicitly indicating the number of indicated technical characteristics. Thus, the characteristics defined with “first” and “second” may explicitly or implicitly include at least one of the characteristics. In addition, the technical solutions among various embodiments can be combined with each other, but it must be based on the realization of those skilled in the art. When the combination of the technical solutions is contradictory or impossible, it should be considered that the combination of technical solutions does not exist and is not within the protection scope of the disclosure.

The disclosure provides an intelligent cosmetic mirror with a display function.

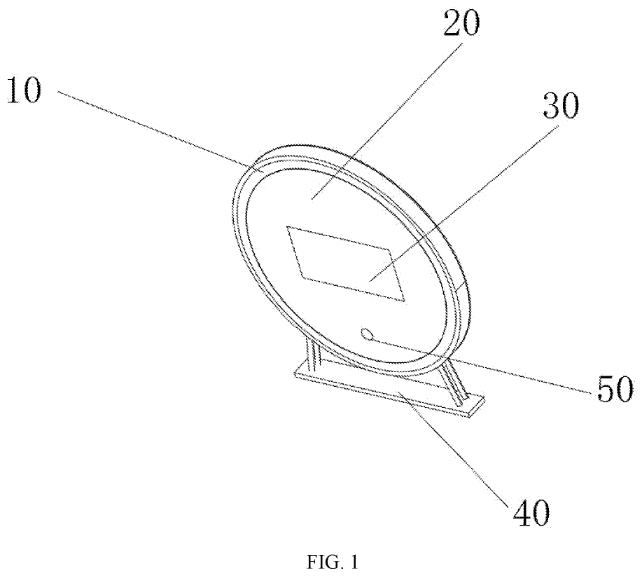

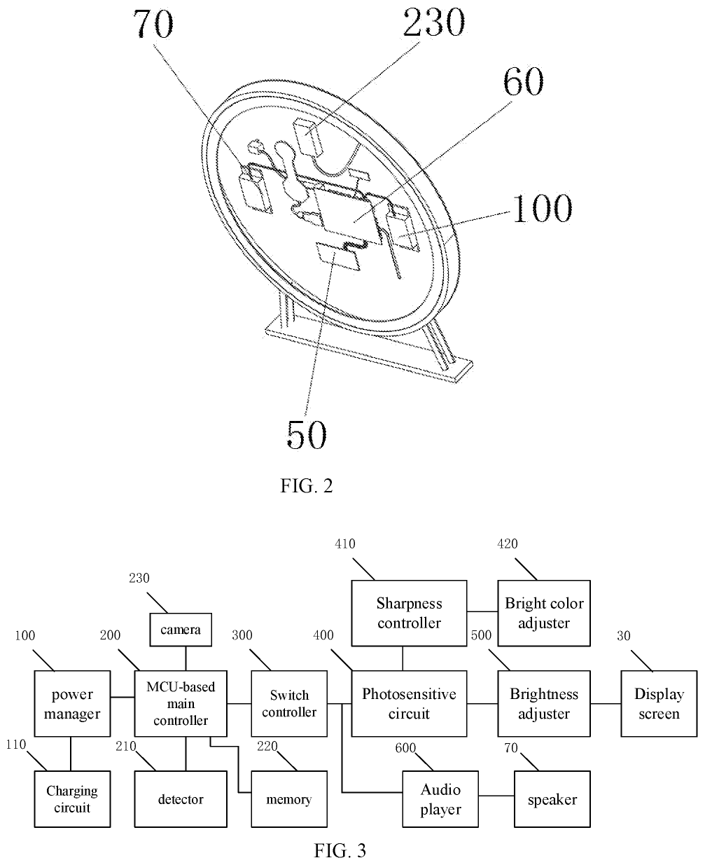

Please refer to FIG. 1, FIG. 2 and FIG. 3, in an embodiment of the disclosure, the cosmetic mirror includes a mirror 10. Preferably, the mirror 10 is a mirror with a semi-perspective function. A display screen 30 is disposed on a mirror surface 20 of the mirror 10. Preferably, the mirror surface 20 is provided with a transparent touch pad (not shown in the figure) thereon. A circuit board 60 is disposed inside the mirror 10. A display circuit is disposed on the circuit board 60. The display circuit includes a power manager 100, a microcontroller unit based (MCU-based) main controller 200, a switch controller 300, a photosensitive circuit 400, and a brightness adjuster 500.

The power manager is configured to supply power to the MCU-based main controller 300. The MCU-based main controller 300 is configured to process and control display information. The switch controller 300 is configured to control switches. The photosensitive circuit 400 is configured to control and process sensitivity. The brightness adjuster 500 is configured to adjust the display brightness.

The MCU-based main controller 200 is configured to control the photosensitive circuit 400 via the switch controller 300, and the photosensitive circuit 400 is configured to control the display screen 30 via the brightness adjuster 500.

In this embodiment, the switch controller 300 preferably includes a touch switch control circuit.

In this embodiment, the display screen 30 preferably includes a touch display screen.

In this embodiment, the switch controller 300 further includes a touch piece switch. A displayer touch piece may also be disposed on the display screen 30.

In this embodiment, the MCU-based main controller includes a step-up direct current converter, the step-up direct current converter may include a LT 3599 chip.

In this embodiment, the display screen 30 is disposed on the mirror surface 20 of the mirror 10 described in this disclosure, and the display circuit is disposed in the mirror 10 described in this disclosure, and this display circuit controls the display screen 30 to display video via the MCU-based main controller, so that when women use the cosmetic mirror to make up, they can display makeup and other teaching contents through the display screen 30, and learn while making up, which enhances the fun of makeup. At the same time, the function of the cosmetic mirror is further increased, and the practicality of the cosmetic mirror is also enhanced.

In this embodiment, the power manager 100 preferably includes a charging circuit 110 which is used to charge the power manager 100.

Referring to FIG. 2, the power manager 100 is disposed on a side of the circuit board 60 and disposed inside the mirror 10.

The charging circuit 110 charges the power manager 100, which ensures that the cosmetic mirror of the disclosure can work uninterruptedly and greatly improves efficiency.

In this embodiment, the MCU-based main controller 200 preferably includes a camera 230, the camera 230 is used to capture image information.

In this embodiment, the information collected by the camera 230 can be displayed via the display screen 30 controlled by the MCU-based main controller 200. In order to facilitate the comparison of the effect after a woman's make-up, the camera will give make-up modification suggestions by taking pictures and then making a photo comparison.

Referring to FIG. 2, the camera 230 is placed inside the mirror 10 and on top of the circuit board 60.

In this embodiment, the MCU-based main controller 200 includes a detector 210, which is used to detect the information processed by the MCU-based main controller 200.

In this embodiment, the detector 210 is able to detect the information processed by the MCU-based main controller 200, which ensures the correctness of the information processed by the MCU-based main controller, and further ensures that the cosmetic mirror can be used safely and reliably.

In this embodiment, the MCU-based main controller 200 may include a memory 220, which is used to store the information processed by the MCU-based main controller 200.

In this embodiment, the display circuit includes an audio player 600 and a speaker 70. The MCU-based main controller 200 controls the audio player 600 through the switch controller 300. The audio player 600 controls the speaker 70 to output sound signals through the speaker 70.

In this embodiment, the speaker 70 is mounted on another side of the circuit board 60 and located inside the mirror 10. The MCU-based main controller 200 controls the speaker 70 to play sound through the switch controller 300, so that this cosmetic mirror of the disclosure not only has the function of playing video images, but also has voice output, which further enhances the function of the cosmetic mirror and further expands its practicability.

In this embodiment, the photosensitive circuit 400 includes a sharpness controller 410 and a bright color adjuster 420. The sharpness controller 410 is configured to control the sharpness of the display screen 30. The bright color adjuster 420 is configured to adjust the brightness of the color on the display screen 30.

The MCU-based main controller 200 controls the photosensitive circuit 400 via the switch controller 300, and the photosensitive circuit 400 is configured to control the bright color adjuster 420 via the sharpness controller 410.

In the disclosure, using the photosensitive circuit 400 to control the bright color adjuster 420 via the sharpness controller 410, which controls and adjusts the display screen 30 to display content more conveniently and intelligently.

In this embodiment, the mirror surface 20 is provided with a key switch 50.

In this embodiment, the display screen 30 is controlled by the key switch 50 to display, which is freer, more convenient, and more practical.

In this embodiment, a support frame 40 is disposed at the bottom of the mirror surface 20, and the support frame 40 is a triangular support frame, so the use of the cosmetic mirror of the disclosure is more stable and reliable.

The intelligent cosmetic mirror with the display function provided by the disclosure can not only make up, but also carry out teaching demonstration and guidance while making up, manicure and facial massage, which is safe and reliable.

The cosmetic mirror with the display function provided by the disclosure has high intelligence, diverse functions and strong practicability. It is not only convenient to use, but also has a good sense of experience, and is deeply loved by consumers.

The above are only the preferred embodiments of the disclosure, which does not limit the scope of the disclosure. Without departing from the spirit and scope of the disclosure, the disclosure will also have various changes and improvements. Under the concept of the disclosure, the equivalent structural transformation made by using the contents of the specification and attached drawings of the disclosure, or directly/indirectly applied in other relevant technical fields are included in the scope of protection of the disclosure.

What is claimed is:

1. A cosmetic mirror, comprising:
a mirror;
a display screen, disposed on a mirror surface of the mirror;
a circuit board, disposed inside the mirror;
a display circuit, disposed on the circuit board; wherein the display circuit comprises: a power manager, a microcontroller unit based (MCU-based) main controller, a switch controller, a photosensitive circuit, and a brightness adjuster;
wherein the power manager is configured to provide a power to the MCU-based main controller, the MCU-based main controller is configured to control the photosensitive circuit through the switch controller, and the photosensitive circuit is configured to control the display screen through the brightness adjuster.

2. The cosmetic mirror according to claim 1, wherein the MCU-based main controller comprises a step-up direct current converter.

3. The cosmetic mirror according to claim 2, wherein the power manager comprises: a charging circuit, and the charging circuit is configured to charge the power manager.

4. The cosmetic mirror according to claim 3, wherein the MCU-based main controller comprises: a detector, and the detector is configured to detect information processed by the MCU-based main controller.

5. The cosmetic mirror according to claim 4, wherein the MCU-based main controller further comprises: a camera, and the camera is configured to collect image information.

6. The cosmetic mirror according to claim 5, wherein the MCU-based main controller further comprises: a memory, and the memory is configured to store the information processed by the MCU-based main controller.

7. The cosmetic mirror according to claim 6, wherein the display circuit further comprises: an audio player connected to the switch controller and a speaker connected to the audio player, the MCU-based main controller is configured to control the audio player through the switch controller, and the audio player is configured to output audio signals through the speaker.

8. The cosmetic mirror according to claim 7, wherein the photosensitive circuit comprises: a sharpness controller and and a bright color adjuster, the MCU-based main controller is configured to control the photosensitive circuit through the switch controller, and the photosensitive circuit is configured to control the bright color adjuster through the sharpness controller.

9. The cosmetic mirror according to claim 1, further comprising:
a key switch, disposed on the mirror surface.

10. The cosmetic mirror according to claim 9, further comprising:
a support frame, disposed at a bottom of the mirror surface.

11. A cosmetic mirror, comprising:
a mirror;
a display screen, disposed on a mirror surface of the mirror;
a circuit board, disposed inside the mirror;
a display circuit, disposed on the circuit board; wherein the display circuit comprises: a microcontroller unit based (MCU-based) main controller;
wherein the MCU-based main controller is configured to control the display screen to display makeup teaching videos or obtain image information of a user and control the display screen to display the image information of the user.
